(19) United States
(12) Patent Application Publication
(10) Pub. No.: US 2008/0179783 A1
(43) Pub. Date: Jul. 31, 2008

(54) Extruded Fibrous Silicon Carbide Substrate and Methods for Producing the Same

(75) Inventors: James Jenq Liu, Mason, OH (US); Bilal Zuberi, Cambridge, MA (US); Jerry G. Weinstein, Malta, NY (US)

Correspondence Address: GEO2 TECHNOLOGIES, 12-R CABOT ROAD, WOBURN, MA, 01801, US

(73) Assignee: GEO2 Technologies, Inc., Woburn, MA (US)

(21) Appl. No.: 11/669,683

(22) Filed: Jan. 31, 2007

(51) Int. Cl. B32B 3/12

(52) U.S. Cl. 264/211; 210/348; 428/116

(57) ABSTRACT

A fibrous silicon carbide substrate is disclosed that provides porosity through an open network of pores resulting from an intertangled arrangement of silicon carbide fibers. The fibrous structure is formed from mixing carbon or organic fibers with silicon based additives, and forming a honeycomb substrate. The carbon or organic fibers are heated in an inert environment to form silicon carbide through a reaction of the carbon in the fibers and the silicon-based additives.

### BACKGROUND OF THE INVENTION

The present invention relates generally to silicon carbide substrates useful for filtration and/or high temperature chemical reaction processing, such as a catalytic host. The invention more particularly relates to a substantially fiber-based silicon carbide substrate and methods for producing the same.

Ceramic honeycomb substrates are commonly used in industrial and automotive applications where inherent material stability and structural integrity are needed at elevated operating temperatures. Ceramic honeycomb substrates provide high specific surface area for effective filtration and support for efficient catalytic reactions. For example, in automotive applications, ceramic substrates are used in catalytic converters to host catalytic oxidation and reduction of exhaust gases, and to filter particulate emissions.

Ceramic honeycomb substrates are typically used in a Diesel Particulate Filter (DPF) to trap diesel exhaust particles, such as soot. When used in a DPF, the ceramic honeycomb is fabricated in a wall-flow configuration by selectively plugging alternate channels to form inlet channels and outlet channels. Every other extruded channel is plugged on the inlet side, and the remaining channels are plugged on the outlet side, thereby forcing the exhaust flow into the inlet channels, through the porous ceramic material that forms the walls of the channels, and out of the filter through the outlet channels. During operation, the soot particles accumulate on the surface of the inlet channel walls, which will ultimately increase the system backpressure. The diesel engine control system monitors backpressure and other indicators, and periodically initiates a regeneration of the filter through a controlled burn-off of the accumulated soot. If the diesel engine controls fail to maintain control of the periodic filter regeneration, too much soot may accumulate and an uncontrolled regeneration may occur, which can result in extremely high temperature gradients within the honeycomb filter, leading to potential failure of substrates.

DPF substrates have been fabricated from an extruded powder-based ceramic material, such as cordierite or silicon carbide. Cordierite, 2MgO.2Al₂O₃.5SiO₂, is a commonly used ceramic material for monolithic catalyst support applications, such as vehicular catalytic converters. Cordierite is typically formed by extruding a mixture of particles of kaolin, talc, calcined kaolin, calcined talc, alumina, aluminum hydroxide, and silica, followed by a high temperature firing process to form cordierite in-situ. The choice of raw materials and processing determines the porosity created in the side walls. The material exhibits a relatively low melting point compared to the operating temperature of a DPF during regeneration. Cordierite is a relatively inexpensive to fabricate, and has a low thermal coefficient of expansion, but the material cannot maintain structural integrity when operating temperatures exceed 1300° Celsius. That, combined with occasional cracking observed when large thermal gradients are created during regenerations, can lead to catastrophic failures.

Silicon carbide, as a material, is desirable for high temperature filtration applications since the material exhibits significantly high thermal conductivity as well as high volumetric heat capacity, that effectively reduce the magnitude of thermal gradients during regeneration in a DPF ceramic honeycomb substrate. Silicon carbide is also chemically stable and inert, and mechanically strong when bonded. Current commercial silicon carbide substrates are typically formed by extruding a mixture of silicon carbide particles and an organic binder, followed by a sintering process that burns off the binder and sinters the silicon carbide particles into a porous structure. In another example, silicon metal powder is used to bond SiC particles together. The drawback of extruding SiC powders is that the highly abrasive particles rapidly wear extrusion dies and equipment used in expensive high pressure extruders. Additionally, the sintering process requires temperatures sometimes in excess of 2000 degrees Celsius for long periods (8-12 hours or more) in an inert environment such as argon.

Porous ceramic honeycomb substrates can also be made from ceramic fibers, as disclosed in commonly owned U.S. Pat. No. 6,946,013, and commonly owned U.S. patent applications Ser. No. 10/833,298 (published as US2005/0042151) and Ser. No. 11/322,544 (published as US2006/0120937), all incorporated herein by reference. The advantage of a fibrous ceramic structure is the improved porosity, permeability, and specific surface area that results from the open network of pores created by the intertangled ceramic fibers, the mechanical integrity of the bonded fibrous structure, and the inherent low cost of extruding and curing the ceramic fiber substrates. The commercial application of this technology, however, is limited by the availability of low cost ceramic fibers. Low cost silicon carbide fibers are not readily or commercially available.

Accordingly, there is a need for fibrous ceramic honeycomb structure that possesses the thermal and mechanical properties of a silicon carbide honeycomb substrate, with the performance and fabrication cost advantage of alternative ceramic materials and fabrication processes.

### BRIEF SUMMARY OF THE INVENTION

The present invention provides an improved silicon carbide substrate that can be manufactured using lower cost materials and processes, yet provide improved performance through increased porosity and permeability. Accordingly, the object of the present invention is directed at methods and processes for forming a substantially fiber-based silicon carbide structure and apparatuses or formed shapes having a fibrous silicon carbide microstructure.

Specifically, the invention is directed at an extrudable mixture for forming a fibrous silicon carbide substrate through an extrusion process, using the raw materials of carbon, carbonaceous and carbon precursor (i.e. organic) fibers and silicon-based additives. The combination of both carbon fiber and silicon based additives, when extruded into a green substrate, and when heated in a oxidative protective atmosphere or vacuum, forms silicon carbide fibers as a reaction between carbon and the silicon based additives.

In a specific embodiment of the invention, silicon carbide fibers are formed from the mixture of carbon fibers and silicon based additives in the form of colloidal silica, or amorphous silica. Alternatively, the silicon based additives can be provided in the form of silicon metal particles, or tetraethyl orthosilicate (TEOS), and other silicon containing polymers such as silazanes, silanes and silicates such as sodium silicate.

In yet another aspect of the invention, organic fibers are mixed with silicon based additives, and extruded into a green substrate. During the subsequent heating operations, the organic fiber is carbonized into carbon fiber, and through the continued application of heat, silicon carbide fibers are formed from reaction of the carbonized organic fibers and the silicon based additives. Extrusion of carbon, carbonaceous, or organic fibers and the subsequent formation of silicon carbide fibers in-situ, avoids the need to find commercially available silicon carbide fibers and the associated costs of processing the silicon carbide material in the extrusion process.

These and other features of the present invention will become apparent from a reading of the following descriptions, and may be realized by means of the instrumentalities and combinations particularly pointed out in the appended claims.

### BRIEF DESCRIPTION OF THE SEVERAL VIEWS OF THE DRAWING

The drawings constitute a part of this specification and include exemplary embodiments of the invention, which may be embodied in various forms.

FIG. 1 is a schematic flowchart illustration of the process for producing a fibrous silicon carbide substrate according to the present invention.

FIG. 2 is a schematic flowchart illustration of an alternate process for producing a fibrous silicon carbide substrate according to the present invention.

FIG. 3 is a representation of the form of the materials used in the methods of the present invention.

FIG. 4 is a representation of the relationship of the materials used in the methods of to the present invention to form silicon carbide fibers.

FIG. 5 is a representation of the silicon carbide fiber made from the process of the present invention.

FIG. 6 is a representation of the form of the materials used in an alternate embodiment of the present invention.

FIG. 7 is a representation of the relationship of the materials used in the methods of an alternate embodiment of the present invention to from silicon carbide fibers.

FIG. 8 is a representation of a photograph of a scanning electron microscopic image of an exemplary embodiment of the present invention.

FIG. 9 is a representation of an x-ray diffraction (XRD) analysis of an exemplary embodiment of the present invention.

FIG. 10 is a depiction of various honeycomb substrates according to the present invention.

FIG. 11 is a cross-sectional representation of a high temperature filtration device that contains a honeycomb substrate according to the present invention.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure or manner.

The present invention relates to an extruded porous ceramic substrate composed of silicon carbide fibers, and a method for producing the same. Silicon carbide is a ceramic compound of silicon and carbon, with a chemical designation of SiC, with properties that characterize the material as a thermally conductive, and mechanically durable material. Silicon carbide is typically manufactured through the combination of silica sand and carbon particles at a temperature between 1400-2500° Celsius. Most silicon carbide produced for industrial purposes is used for abrasives, such as grinding wheels and sandpaper, in addition to porous honeycomb substrates. Silicon carbide is not naturally occurring, but rather produced synthetically for industrial purposes. While it may be technically feasible to mix and extrude a mixture of silicon carbide fibers to produce a porous substrate, the relatively high cost of obtaining suitable silicon carbide fibers, and the inherent difficulties of processing the material in an extrusion process, result in economic challenges that impair its commercial applicability.

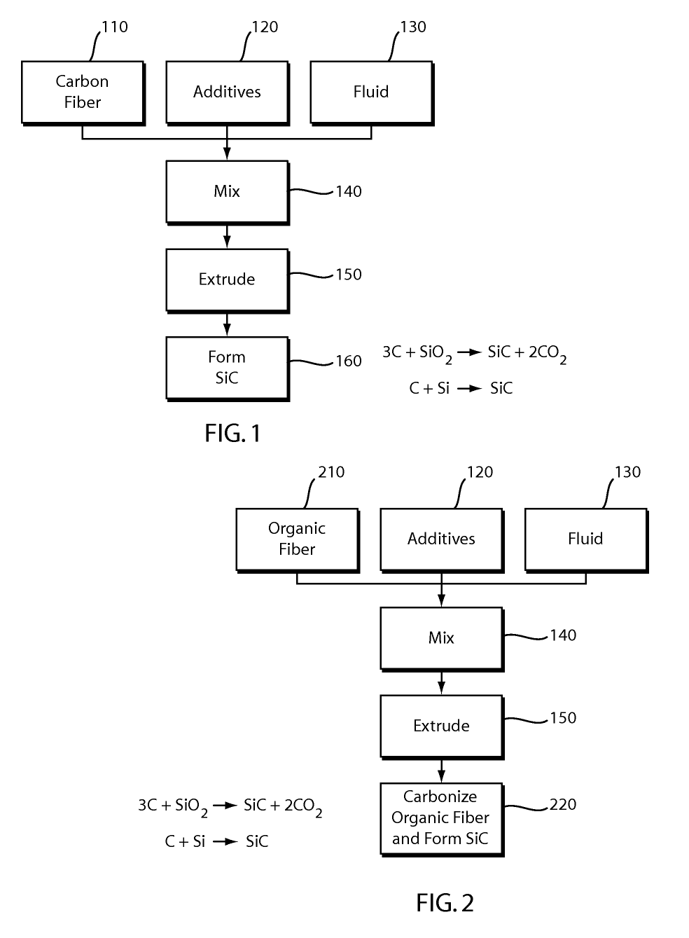

FIG. 1 depicts a flowchart of a method for producing a fibrous silicon carbide substrate according an embodiment of the present invention. Generally the method 100 combines carbon fiber 110, (carbonaceous type fiber) additives 120, and a fluid 130 in a mixing step 140, that is then extruded 150 into a honeycomb form, where the carbon fibers 110 and the additives 120 are reaction formed into silicon carbide fibers 160. By forming silicon carbide fibers in-situ, the commercial economic advantages of mixing and extruding compliant, low cost materials are realized as a low-cost implementation of a high performance ceramic substrate material.

The carbon fiber 110 can be Polyacrilnitrizile (PAN) fibers or Petroleum Pitch fibers, of the type commonly used in carbon-fiber reinforced composites, or a variety of carbonized organic fibers such as polymeric fibers, rayon, cotton, wood or paper fibers, or polymeric resin filaments. The carbon fiber diameter can be 1 to 30 microns in diameter, though for intended applications such as exhaust filtration, a preferred range of fiber diameter is 3 to 10 microns can be used. The fiber diameter and length is not materially changed in the subsequent formation of silicon carbide, and thus, the selection of the carbon fiber characteristics should generally match the desired fiber structure of the final product. PAN or Pitch fibers, and carbonized synthetic fibers, such as rayon or resin, will have more consistent fiber diameters, since the fiber diameter can be controlled when they are made. Naturally occurring fibers, such as carbonized cotton, wood, or paper fibers will have an increased variation and less-controlled fiber diameter. The carbon fibers 110 are typically chopped or milled to any of a variety of lengths for convenience in handling, and to ensure even distribution of fibers in the mix. It is expected that the shearing forces imparted on the fibers during the subsequent mixing step 140 will shorten at least a portion of the fibers, so that the fibers have a desired length to diameter aspect ratio between 1 and 1,000 in their final state after extrusion, though the aspect ratio can be expected to be in the range of 1:100,000.

The additives 120 include at least two primary groups of constituents: silicon-based particles, such as silicon metal particles or silicon oxide (silica) particles, such as colloidal silica; and a binder. In some cases, a chemical carrier, such as silicon-containing polymers, or solutions, etc, may also be used to provide silicon into the system to react with the carbon to form silicon carbide. The silicon-based particles or chemical or polymer solutions are necessary to react and combine with the carbon within the fibers to form silicon carbide fibers when heated under appropriate temperature and environmental conditions (vacuum or inert atmosphere). The binder, plasticizers, etc are necessary to provide plasticity in the mixture and to provide adequate cohesive forces in the extruded body to form the honeycomb substrate, such as in the extrusion process 150. The additives 120 may also include plasticizers, dispersants, pore formers, processing aids, and strengthening materials to further manipulate the chemistry, porosity, pore-size, pore structure, mechanical and thermal characteristics. As will be discussed, the selection of the additives must be made so as to not inhibit the desired formation of silicon carbide from the silicon-based particles and the carbon fiber 110.

In order to form silicon carbide fibers from the carbon fibers 110 and the additives 120, the silicon content of the silicon-based particles must be provided in approximately a stoichiometric ratio to form silicon carbide, and evenly distributed throughout the extruded or formed substrate. Silicon-based particles can be material provided in the form of silicon metal particles, fumed silicon, silicon microspheres, silica-based aerogels, polysilicon, silane or silazane polymers, or from other silicon-based compounds, such as amorphous, fumed, or colloidal silicon dioxide (silica). Colloidal silica can also be used for the silicon-based component of the additives 120. Colloidal silica is a stable dispersion of discrete particles of amorphous silica (SiO₂), sometimes referred to as a silica sol. Colloidal silica is commercially available with particle sizes between 5 nm and 5 μm dispersed in an aqueous or solvent solution, typically around 30-50% solid concentration. The small particle size of colloidal silica, when mixed with the carbon fibers 110, permits a uniform distribution of the silicon-based component with the carbon fiber, so that the silica can effectively coat the surface of the individual carbon fibers. The stoichiometric ratio of silicon carbide will be attained with a ratio of three parts carbon to one part Silica (3:1), though the ratio of materials added to the mixture can include excess carbon or excess silica, for example, the mixture can be in the range of about 5:1 and 2:1 carbon:silica.

Alternatively, the silicon-based constituent of the additives 120 can be silicon metal particles with a sufficiently fine particle size to be fully and evenly dispersed during processing. Purity of the silicon is not essential for the silicon carbide formation reaction to occur, but metallic contaminants may alter the application and effectiveness of any subsequent catalyst layer. Preferably, the particle size of the silicon-based constituent of the additives 120 is as small as commercially available. Silicon powder in the 1 to 4 μm size or silicon nanoparticles are desirable, though lower cost materials are typically associated with particles in the 30 to 60 μm size. The larger particles are sufficiently small enough to be effectively distributed for the formation of silicon carbide. The stoichiometric molar ratio of silicon carbide will be attained with a ratio of about 1:1 carbon:silicon, though the ratio can be extreme, resulting in either excess carbon or excess silicon. Excess silicon is advantageous to make up for silicon or silicon monoxide that may be lost during the process (due to volatility at high temperatures), and/or to provide available silicon for metal bonds. Additionally, excess silicon residing on the formed silicon carbide fibers can act as a protective coating, which can be advantageous when used with catalysts that include materials such as potassium that can otherwise chemically degrade the silicon carbide material.

The additives 120 include a binder component that is necessary to provide plasticity and extrudability of the mixture. The binder provides green strength of the substrate until the final silicon carbide fibrous structure is fully formed in the forming step 160, by retaining the relative position of the carbon fibers 110 and the silicon-based constituents of the additives 120 in the mixture. As will be explained in further detail below, the binder must be selected so that it can be selectively removed from the mixture during the subsequent forming process 160 without inhibiting the desired formation of silicon carbide from the silicon-based particles and the carbon fiber 110. Acceptable binders include methylcellulose, hydroxypropyl methylcellulose (HPMC), ethylcellulose and combinations thereof In some cases, a binder system that can be thermally disintegrated by converting into volatile species in small or insignificant amount of external oxygen supply can be used. HPMC is a water-soluble polymer that facilitates particle distribution during the mixing step 140 and provides sufficient lubricity and plasticity of the mixture for extrusion of honeycomb forms in the extrusion step 150. For non-aqueous solutions, additives such as ethycellulose add plasticity to the mix and serves as good extruding aids.

Additives 120 optionally include pore formers, bonding agents and other processing aids. Pore formers, when included as an additive 120, are non-reactive material that occupy space during mixing and extrusion, though are removed eventually via pyrolysis or by thermal degradation or volatilization. For example, microwax emulsions or phenolic resin particles can be added as an additive 120, that will burn out during the subsequent forming process 160, resulting in increased porosity of the resulting structure. Additionally, bonding agents can be included as an additive 120 that remain within the resulting structure contributing to fiber-to-fiber bonds between adjacent fibers. Bonding agents can form metal bonds through the addition of particles of aluminum, titanium, or excess silicon, or glass/ceramic bonds through the addition of an oxide-based ceramic or clay, such as alumina, zirconia, or a clay such as benonite. Bonding agents, as well as the silicon-based additives can also act as pore formers when they are provided in a low density form, such as hollow spheres or aerogels.

The fluid 130 is added as needed to attain a desired rheology suitable for extrusion, or other desired shape formation at step 150. Water is typically used, though solvents of various types can be utilized, along with liquids associated with additives such as colloidal silica, silanes or silazane reagent liquids. Rheological measurements can be made during the mixing process 140 to evaluate the rheology of the mixture compared with a desired rheology for the extrusion step 150.

The carbon fibers 110, additives 120, and fluid 130 are mixed at step 140 to evenly distribute the materials into a homogeneous mass with a desired rheology for extrusion, or other shape forming processing. This mixing may include dry mixing, wet mixing, shear mixing, and kneading, which is necessary to evenly distribute the materials into a homogeneous mass while imparting requisite shear forces to break up and distribute or de-agglomerate the fibers, particles and fluid. The amount of mixing, shearing, and kneading, and duration of such mixing processes depends on the selection of fibers 110, additives 120, and fluid, along with selection of mixer type 130 in order to obtain a uniform and consistent distribution of the materials within the mixture, with the desired rheology suitable for extrusion using piston or screw extruders.

Extrusion of ceramic materials is generally considered to be the most cost efficient method for producing honeycomb ceramic substrates. Other methods of forming honeycomb substrates are known to one skilled in the art, such as casting, injection molding, broaching, and others, which are contemplated to fall within the scope of the appended claims. For the purposes of this description, the method for shaping the mixture into a honeycomb substrate form will be described as the preferred extrusion process.

The extrusion process for the mixture of carbon fibers 110, additives 120, and a fluid 130 according to the present invention is similar to the extrusion of powder-based ceramic materials. The mixture containing a suitable plasticizing aid such as HPMC, and having a suitable rheology, is forced under pressure through a honeycomb die to form a generally continuous honeycomb block that is cut to a desired length. The honeycomb die determines the size and geometry of the honeycomb channels, and can be rectangular, triangular, hexagonal, or other polygonal shaped channels, depending on the design of the extrusion die. The extrusion system used for the extrusion step 150 can be of the type typically used to extrude powder-based ceramic materials, for example, a piston extruder or screw-type extruder. One skilled in the art will appreciate that certain aspects of the mixing step 140 can be performed in a screw extruder during the extrusion step 150. The extrusion step 150 produces a green substrate, which has sufficient green strength to hold its shape and fiber arrangement during the subsequent forming step 160.

Extruding the extrudable mixture of carbon fiber 110, additives 120 and fluid 130 creates a unique microstructure of intertangled fibers in a honeycomb substrate. Shear forces that act upon the material as it is forced through the die result in a tendency for orientation of the fibers in the direction of extrusion along the wall surface of the honeycomb channels. Within the channel walls, the fibers are generally aligned in the extrusion direction due to the shear forces imparted on the material during extrusion, but the alignment can be less than the alignment of the fibers at the wall surface. The resulting microstructure has an even distribution of relatively small spacing between the aligned fibers at the surface of the channel wall, with a broader range of spacing between fibers within the channel walls. After the subsequent forming step 160, when the binder and fluid is removed while maintaining the relative fiber spacing throughout the substrate, the resulting structure becomes porous. The porosity of the substrate, as a result of the alignment of the fibers during extrusion, exhibits an even distribution of small pores at the channel walls, with a broader distribution of pores within the open network of pores resulting from the spacing between fibers. Additionally, while the surface of the channel walls can be viewed as a two-dimensional mat of interlocked and interconnected fibers, distinguished by the internal regions of the channel wall, which is a three-dimensional structure of interlocked and interconnected fibers, the surface of the channel walls is not entirely planar. Fiber ends have a tendency to protrude out at an angle from the surface. These protrusions are particularly useful when the substrate is used as a filter, such as a diesel particulate filter, since the protrusion can act as nucleation, coagulation or trapping sites for cake filtration. The distribution of these sites over the surface of the channel walls ensures that a uniform accumulation of particulates can accumulate, which acts to improve trapping efficiency and to regulate regeneration of the filter.

The alignment of fibers, pore size, pore distribution, nucleation, coagulation, and trapping site distribution, and pore characteristics between wall surface and internal regions can be controlled by altering parameters of the extrusion process. For example, the rheology of the mixture, diameter and aspect ratio distributions of the fibers, characteristics of the additives, extrusion die design, and extrusion pressure and speed can be varied to attain desired characteristics in the resulting structure of the substrate.

The forming step 160 effectively converts the carbon fiber 110 that is mixed with the silicon-based additives 120 within the green substrate into silicon carbide fibers while maintaining the honeycomb structure formed by extrusion. The forming step 160 can be performed as the sequence of three phases: drying; binder burnout; and reaction-formation of SiC. In the first phase, the green substrate is dried by removing the fluid using relatively low temperature heat with or without forced convection to gradually remove the water. Alternative methods of drying can be implemented, such as vacuum freeze drying, solvent extraction, or electromagnetic/radio frequency (RF) drying methods. The use of RF to dry the green substrate can be challenging due to the conductivity of the ceramic fibers, thus requiring controlled modulation of the RF power. The fluid must not be removed too rapidly from the substrate so that drying cracks due to shrinkage do not form. Typically, for aqueous based systems, the green substrates can be dried when exposed to temperatures between 90 and 150 degrees Celsius for a period of about one hour, though the actual drying time may vary due to the size and shape of the substrates, with larger parts often taking longer to fully dry.

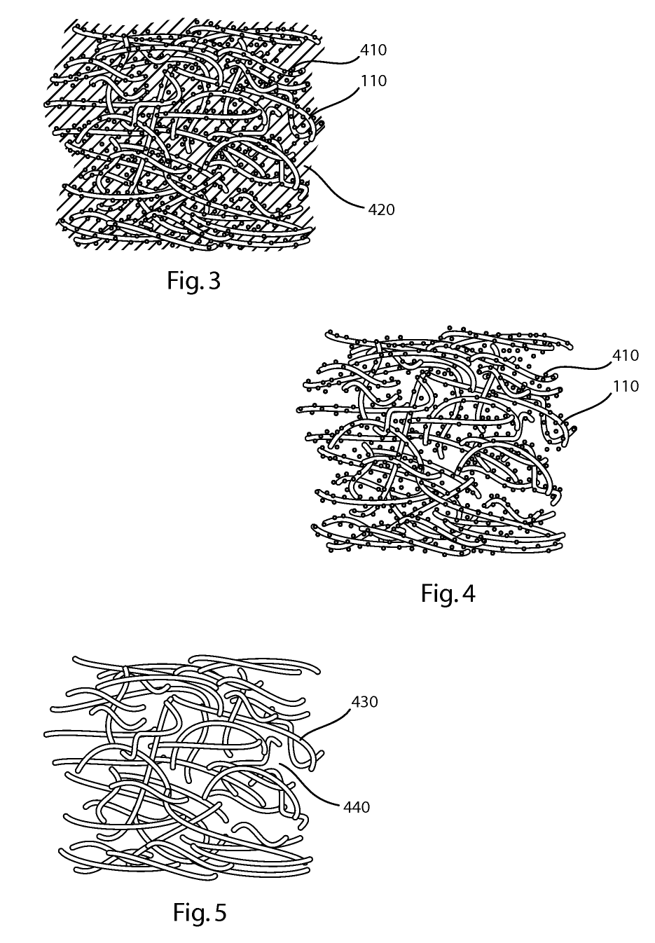

FIG. 3 is a graphical representation of the mixture of carbon fibers 110, and the additives, shown as the silicon-based component 410 (shown as distributed spheres), and the binder component 420 (shown as the cross-hatched region). In this phase the carbon fiber, and silicon-based additives are held in position by the green strength of the binder component 420 of the additives 120.

Once the green substrate is dried, or substantially free of the fluid 130, the next phase of the forming step 160 proceeds to burn out the binder component of the additives 120. In this second phase, the substrate is heated in an inert environment to a temperature that will effectively decompose the binder, without affecting the compositions of the carbon fiber and the silicon-based component of the additives 120. For example, if methylcellulose or HPMC is used for the binder component of the additives 120, this binder will decompose at a temperature of approximately 300 degrees Celsius, and effectively burn out when held at that temperature for approximately one hour. It is important to note that other additives, such as pore formers, plasticizers, and dispersants must be selected so that they either decompose completely or leave a controlled residual carbon layer behind that can be used in the subsequent SiC reaction. Binders and additives should be chosen such that decomposition of the binders, as well as the elimination of any crystalline water from additives such as clay should takes place at temperatures less than 800° C. The resulting structure of the substrate at this phase of the forming step 160 is generally shown in FIG. 4, where the carbon fibers 110 are coated with an even distribution of small particles, or an even coating, of the silicon-based component 410 of the additives 120.

The final stage of the forming process 160 requires heating the remaining structure, i.e., the carbon fiber and the silicon-based component of the additives in an environment sufficient to form silicon carbide from the carbon fibers. The chemical reaction during this final phase of the forming step 160 is generally described to be:

C+Si→SiC

though when the silicon-based component is silica, the reaction can be described to be:

3C+SiO₂→SiC+2CO₂

It is to be appreciated that in this reaction, intermediate transitionary compounds may form before stable SiC is fomed.

The above reaction will take place when the structure is heated to a temperature of about 1400 to 1800 degrees Celsius, for approximately 2 to 4 hours or more, in an inert environment. When silicon metal is included as the silicon-based component of the additives 120, the silicon particles will melt at above 1414 degrees Celsius, which will then wet to, and coat the carbon fibers to convert into silicon carbide. This wetting is optimized in vacuum atmosphere conditions where silicon metal will spontaneously wet elemental carbon, including the fiber itself or wetting of a residual carbon layer remaining from the burn out of a binder additive.

When silica is included as the silicon-based component of the additives 120, there is a solid state (solid-solid) reaction that goes on that is diffusion dependent:

3C+SiO₂→SiC+2CO₂

There may be a secondary reaction is that the SiO2 first vaporizes to SiO, and this then reacts with the carbon to form silicon carbide, thus resulting in the following gas-solid reaction:

2C+2SiO→2SiC+O₂

An inert environment is necessary ensure the absence of oxygen to prevent the oxidation of the carbon into carbon dioxide. The resulting structure is generally shown in FIG. 5, where silicon-carbide fibers 430 are shown in an intertangled and overlapping relationship, forming an open network of pores 440. It can be appreciated that the resulting microstructure formed within the substrate is largely based on the intertangled fiber architecture originally composed of the carbon or organic fibers, and the formation of silicon carbide during the forming step 160 does not substantially change the relative position of the fibers.

The forming step 160 can be carried out in a conventional batch or continuous furnace or kiln. The inert environment can be maintained by purging the furnace or kiln with nitrogen, argon, helium, neon, forming gas and mixtures thereof, or any inert gas or gaseous mixture. It is important to have a little to none partial pressure of oxygen, so as to prevent adverse reactions from occurring that can lead to oxidation and volatilization of the reactive species. Alternatively, the forming step 160 can be performed in a vacuum environment, which would typically require a vacuum of 200.0 torr or less. The forming step 160 can be performed by a sequential progression through multiple batch or continuous kilns, or the sequence of heating steps, i.e., drying, binder burnout, and reaction formation, can be performed in a single facility that can maintain the sequential temperature environments in a manual or automatic fashion.

Referring now to FIG. 2, an alternate embodiment of the method of the present invention is shown. Here, organic fibers 210 are used as the base material to form silicon carbide fibers. The organic fibers 210 are combined with additives 120 and a fluid 130, that are mixed at mixing step 150. The mixture is extruded at step 150 to form a green honeycomb substrate, and the organic fibers are first carbonized and then converted into silicon carbide fibers at step 220. In this embodiment, organic fibers 210 are likely to have sufficient strength for processing through the mixing and extrusion processes, and likely more so than the strength of some of the same fibers that are first carbonized into carbon fibers 110, as described with reference to FIG. 1.

In this alternate embodiment, the organic fibers 210 can be rayon, cotton, wood or paper fibers, or polymeric resin filaments. The fiber diameter can be approximately 1 to 30 microns in diameter, though for intended applications such as exhaust filtration, a preferred range of fiber diameter is 3 to 10 microns The diameter of the organic fibers 210 must account for shrinkage, which can be as much as 70% when carbonized during the formation step 220. Naturally occurring fibers, such as cotton, wood or paper will exhibit significantly more variation in the fiber diameter, compared to synthetically derived fibers, such as rayon or resin. The organic fibers can be chopped or milled to any of a variety of lengths, so that the fibers have a desired length to diameter aspect ratio between 1 and 1,000 in their final state after extrusion, though the aspect ratio can be expected to be in the range of 1:100,000.

The additives 120 include at least two primary groups of constituents: silicon-based particles, such as silicon metal particles or silicon oxide (silica) particles, such as colloidal silica; and a binder. The silicon-based particles are necessary to react and combine with the carbon within the carbonized organic fibers to form silicon carbide fibers. The binder is necessary to provide plasticity in the mixture in order to form the honeycomb substrate, such as in the extrusion process 150. The additives 120 may also include plasticizers, dispersants, pore formers, processing aids, and strengthening materials. The additives must be selected so as to not inhibit the carbonization of the organic fibers 210 nor inhibit the desired formation of silicon carbide from the silicon-based particles and the carbonized organic fiber 210. Carbon particles as a pore former can be included as an additive 120 to provide excess carbon to assist with wetting of the silicon metal during the subsequent formation step 220.

In order to form silicon carbide fibers from the organic fibers 210 and the additives 120, the silicon content of the silicon-based particles must be provided in approximately a stoichiometric ratio to form silicon carbide, and evenly distributed throughout the extruded or formed substrate. Silicon-based particles can be material provided in the form of silicon metal particles, fumed silicon, silicon microspheres, silica-based aerogels, polysilicon, silate or silazane polymers, or from other silicon-based compounds, such as amorphous, fumed, or colloidal silicon silicon dioxide (silica). Colloidal silica can also be used for the silicon-based component of the additives 120. The small particle size of colloidal silica, when mixed with the organic fibers 210, permits a uniform distribution of the silicon-based component with the organic fiber, so that the silica can effectively coat the surface of the individual fibers. The stoichiometric ratio of silicon carbide will be attained with a ratio of three parts of the carbon content of the organic fiber to one part silica (3:1), though the ratio can be in the range of about 5:1 and 2:1 carbon:silica.

Alternatively, the silicon-based constituent of the additives 120 can be silicon metal particles with a sufficiently fine particle size to be fully and evenly dispersed during subsequent processing. Purity of the silicon is not essential for the silicon carbide formation reaction to occur, but metallic contaminants may alter the application and effectiveness of any subsequent catalyst layer. Preferably, the particle size of the silicon-based constituent of the additives 120 is as small as commercially available. Silicon powder in the 1 to 4 μm size or silicon nanoparticles are desirable, though lower cost materials are typically associated with particles in the 30 to 60 μm size. The larger particles are sufficiently small enough to be effectively distributed for the formation of silicon carbide. The stoichiometric molar ratio of silicon carbide will be attained with a ratio of about 1:1 carbon:silicon, though the ratio of materials in the mixture can be extreme, resulting in ether excess carbon or excess silicon. Excess silicon is advantageous to make up for silicon or silicon monoxide that may be lost during subsequent processing, due to volatility at high temperatures, and/or to provide available silicon for the formation of metal bonds between fibers. Additionally, excess silicon residing on the formed silicon carbide fibers can act as a protective coating, which can be advantageous when used with catalysts that include materials such as potassium that can otherwise chemically degrade the silicon carbide material. Excess carbon is advantageous to make up for material lost during carbonization or pyrolysis, or oxidation due to the presence of oxygen during subsequent firings.

The additives 120 include a binder component that is necessary to provide plasticity of the mixture to aid in the forming by such fabrication techniques such as extrusion. The binder also provides green strength of the substrate as formed and after drying until the final silicon carbide fibrous structure is fully formed in the forming step 220, by retaining the relative position of the organic fibers 210 and the silicon-based constituents of the additives 120 in the mixture. As will be explained in further detail below, the binder must be selected so that it can be selectively removed from the mixture during the subsequent forming process 220 without inhibiting the carbonization of the organic fibers 210 and without inhibiting the desired formation of silicon carbide from the silicon-based particles and the carbonized organic fibers 210. Acceptable binders include methylcellulose, hydroxypropyl methylcellulose (HPMC), ethylcellulose and combinations thereof HPMC is a water-soluble polymer that facilitates particle distribution during the mixing step 140 and provides sufficient lubricity and plasticity of the mixture for extrusion of honeycomb forms in the extrusion step 150. Ethylcellulose can be used as a binder in non-aqueous systems.

Additives 120 can optionally include pore formers and bonding agents. Pore formers, when included as an additive 120, are non-reactive material that occupy space during mixing and extrusion, though are removed by pyrolysis or by thermal degradation or volitalization. For example, microwax emulsions or phenolic resin particles can be added as an additive 120, that will burn out during the subsequent forming process 220, resulting in increased porosity of the resulting structure. Additionally, bonding agents can be included as an additive 120 that remain within the resulting structure contributing to fiber-to-fiber bonds between adjacent fibers. Bonding agents can form metal bonds through the addition of particles of aluminum, titanium, or excess silicon, or glass/ceramic bonds through the addition of an oxide-based ceramic or clay, such as alumina, zirconia, glass frits or a clay such as bentonite.

The fluid 130 is added as necessary to attain a desired rheology suitable for extrusion, or other desired shape formation at step 150. Water is typically used, though solvents of various types can be utilized, along with the liquid component of additives such as colloidal silica, silanes, or silazane reagent liquids. Rheological measurements can be made during the mixing process 140 to evaluate the rheology of the mixture compared with a desired rheology for the extrusion step 150.

The organic fibers 210, additives 120, and fluid 130 are mixed at step 140 to evenly distribute the materials into a homogeneous mass with a desired rheology for extrusion, or other shape forming processing. This mixing may include dry mixing, wet mixing, shear mixing, and kneading, which is necessary to evenly distribute the materials into a homogeneous mass while imparting requisite shear forces to break up and distribute or deagglomerate the fibers, particles and fluid. The amount of mixing, shearing, and kneading, and duration of such mixing processes depends on the selection of organic fiber 210, additives 120, fluid 130 and mixer type in order to obtain a uniform and consistent distribution of the materials within the mixture, with the desired rheology.

The extrusion process for the mixture of organic fibers 210, additives 120, and a fluid 130 according to the present invention is similar to the extrusion of carbon fiber-based materials described above. The mixture is forced under pressure through a honeycomb die to form a generally continuous honeycomb block that is cut to a desired length. The honeycomb die determines the size and geometry of the honeycomb channels, and can be rectangular, triangular, hexagonal, or other polygonal shaped channels. As discussed above, the extrusion system used for the extrusion step 150 can be of the type typically used to extrude powder-based ceramic materials, for example, a piston extruder or screw extruder. The extrusion step 150 produces a green substrate, which has sufficient green strength to hold its shape and fiber arrangement during the subsequent forming step 220.

The forming step 220 effectively converts the organic fibers 210 that are mixed with the silicon-based additives within the green substrate into silicon carbide fibers while maintaining the honeycomb structure formed by extrusion. The forming step 220 differs from the forming step 160 described above when carbon fibers or carbonized organic fibers are initially mixed. Here, the forming step 220 requires the conversion of the organic fibers into a carbonized form, while retaining the position and dimensional characteristics of the organic fiber (e.g., diameter, length, etc.). The forming step 220 of FIG. 2 is otherwise similar to the forming step 160 described with reference to FIG. 1.

The forming step 220 can be performed as the sequence of four phases: drying, binder burnout, carbonization; and reaction-formation of SiC. In the first phase, the green substrate is dried by removing the fluid using relatively low temperature heat with or without forced convection to gradually remove the fluid. Alternative methods of drying can be implemented, such as vacuum freeze drying, solvent extraction, or electromagnetic/radio frequency (RF) drying methods. The use of RF is somewhat more adaptable to this alternate embodiment since the fibrous component of the green substrate is not conductive carbon at the time that the substrate is being dried. The fluid must not be removed too rapidly from the substrate so that drying cracks due to shrinkage do not form. Typically, green substrate can be dried when exposed to temperatures between 90 and 150 degrees Celsius for a period of about one hour, though the actual drying time may vary due to the size and shape of the substrates.

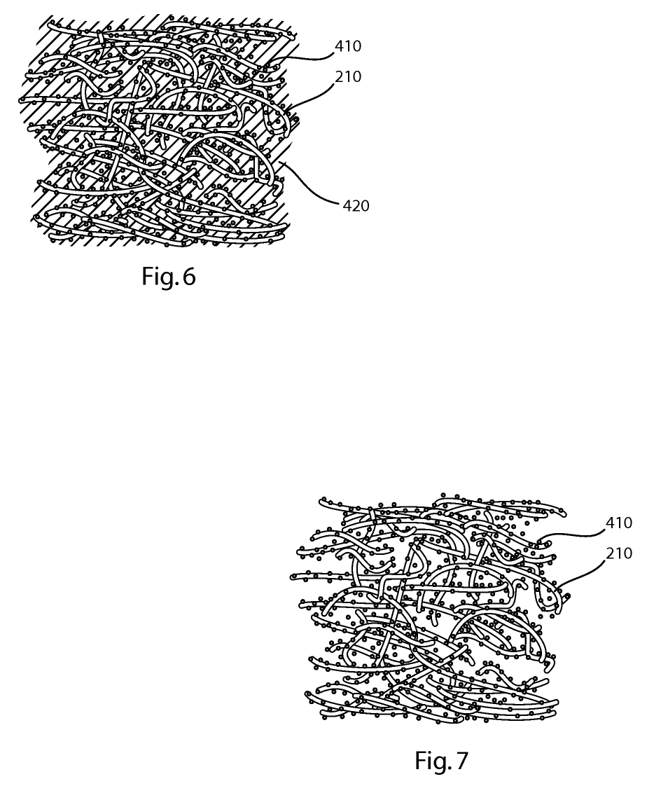

FIG. 6 is a graphical representation of the mixture of organic fibers 210, and the additives, shown as the silicon-based component 410 (depicted as distributed spheres), and the binder component 420 (shown as the cross-hatched region). In this phase, the organic fiber and the silicon-based additives are held in position by the green strength of the binder component 420 of the additives 120.

Once the green substrate is dried, or substantially free of the fluid 130, the next phase of the forming step 220 proceeds to burn out the binder component of the additives 120. In this second phase, the substrate is heated in an inert environment to a temperature that will effectively decompose the binder, without affecting the compositions of the organic fiber and the silicon-based component of the additives 120. For example, in the methylcellulose or HPMC is used for the binder component of the additives 120, the binder will decompose at a temperature of approximately 300 degrees Celsius, and effectively burn out when held at that temperature for approximately one hour. It is important to note that other additives, such as pore formers, plasticizers, and dispersants must be selected so that they can be burned out at a temperature at least less than 600 degrees Celsius, so that the processing environment does not substantially impact the composition of the organic fibers or the silicon-based additives, and have substantially no impact on the subsequent carbonization of the organic fibers. The resulting structure of the substrate at this phase of the forming step 220 is generally shown in FIG. 7, where the organic fibers 210 are coated with an even distribution of small particles of the silicon-based component 410 of the additives 120.

The next phase of the forming process 220 is the carbonization of the organic fibers 210. The organic fibers 210 are converted into elemental carbon through pyrolyzation of the organic material, while maintaining the fibrous structure. The carbonization portion of the forming process 220 can be performed, for example by heating the organic fibers 210 to approximately 1,000 degrees Celsius for about four to five hours in an inert environment. The inert environment is necessary for this step so that the carbon is not oxidized after it is formed, and so that the remaining additives are not oxidized. The temperature of this carbonization phase must be high enough to carbonize the organic materials, but not so high as to impact the remaining additives (i.e., the temperature must be less than the glass transition temperature or melting point of the silicon-based additives 410. The resulting structure of the substrate at this phase of the forming step 220 is generally shown in FIG. 4, where the carbonized organic fibers, now carbon fibers 110 are coated with an even distribution or coating of small particles of the silicon-based component 410 of the additives 120.

The final stage of the forming process 220 requires heating the remaining structure, i.e., the carbonized organic fiber and the silicon-based component of the additives in an environment sufficient to form silicon carbide from the carbonized organic fibers. The chemical reaction during this final phase of the forming step 220 is generally described to be:

C+Si→SiC

though when the silicon-based component is silica, the reaction can be described to be:

C+SiO₂→SiC+O₂

This reaction will take place when the structure is heated to a temperature of at least 1400° Celsius or higher for an extended period of time, for example 4 hours, in an inert environment. An inert environment is necessary ensure the absence of oxygen to prevent the oxidation of the carbon into carbon dioxide. The resulting structure is generally shown in FIG. 5, where silicon-carbide fibers 430 are shown in an intertangled and overlapping relationship, forming an open network of pores 440.

The forming step 220 can be carried out in a conventional batch or continuous furnace or kiln. The inert environment can be maintained by purging the furnace or kiln with nitrogen, argon, helium, neon, and mixtures thereof, or any inert gas or gaseous mixture. Alternatively, the forming step 220 can be performed in a vacuum environment, which would typically require a vacuum of 200 torr or less. The forming step 220 can be performed by a sequential progression through multiple batch or continuous kilns, or the sequence of heating steps, i.e., drying, binder burnout, and reaction formation, can be performed in a single facility that can maintain the sequential temperature environments in a manual or automatic fashion.

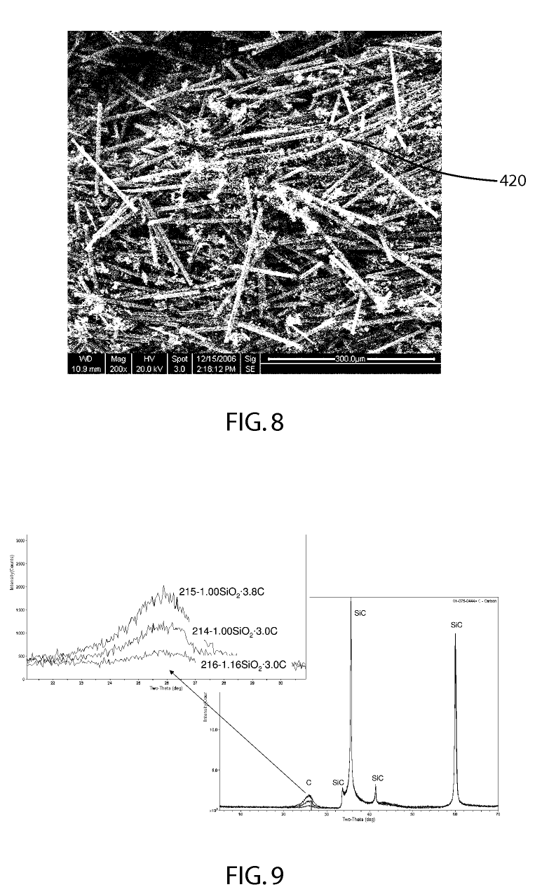

FIG. 8 shows a scanning electron microscopic image of the resulting structure of the present invention. Silicon carbide fibers 430 that were formed from the reaction-formation of an extruded mixture of carbon fibers and silicon-based additives are shown. The fibers are generally oriented in one direction as a result of the extrusion process, while forming an overlapping and intertangled relationship to form an open network of pores. FIG. 9 depicts an x-ray diffraction (XRD) analysis of the resulting structure, specifically indicating that carbon fibers were formed into silicon carbide. The porosity, permeability, and strength of the resulting structure has been found to be particularly adaptable to high temperature filtration applications, such as exhaust filtration as a diesel particulate filter.

The additives 120 can also include a bonding agent to provide enhanced strength of the final substrate through the formation of bonds between the fibers, such as through the formation of ceramic or glass bonds, or metal bonds. Ceramic or glass bonds can be formed through the addition of an oxide-based ceramic, such as alumina, zirconia, or a glass frit, as well as a clay such as bentonite. Additional quantities of silica can alternatively be added in excess of the stoichiometric quantity necessary to form silicon carbide, wherein the excess silica can form glass bonds between the fibers and at the intersecting nodes of the fibrous network of open pores. Tetraethyl orthosilicate (TEOS), and other silicon containing materials such as silazanes, silanes and silicates such as sodium silicate can also be added to contribute in the formation of ceramic or glass bonds, while contributing silicon to the reaction of silicon carbide formation. Metal bonds can be formed through the addition of titanium or excess silicon metal, which can be added in excess of the stoichiometric quantity necessary to form silicon carbide, where the titanium or silicon metal will melt, wet to the fibers, and flow to the nodes of intersecting fibers. The bonding agent, when included as an additive 120, will form ceramic, glass, or metal bonds within the substrate during the sintering processes performed at the formation step 160 or the formation step 220. Polymer bonds can also be formed through the inclusion of preceramic polymers as an additive 120. Preceramic polymers are typically liquid polymer precursors that convert to a ceramic material upon pyrolysis. Commercially available preceramic polymers convert into silicon carbide, silicon nitride, silicon oxycarbide, and silicon oxynitride. For example, STARFIRE SMP-10, available from Starfire Systems of Malta, N.Y., is a single-component liquid precursor to silicon carbide.

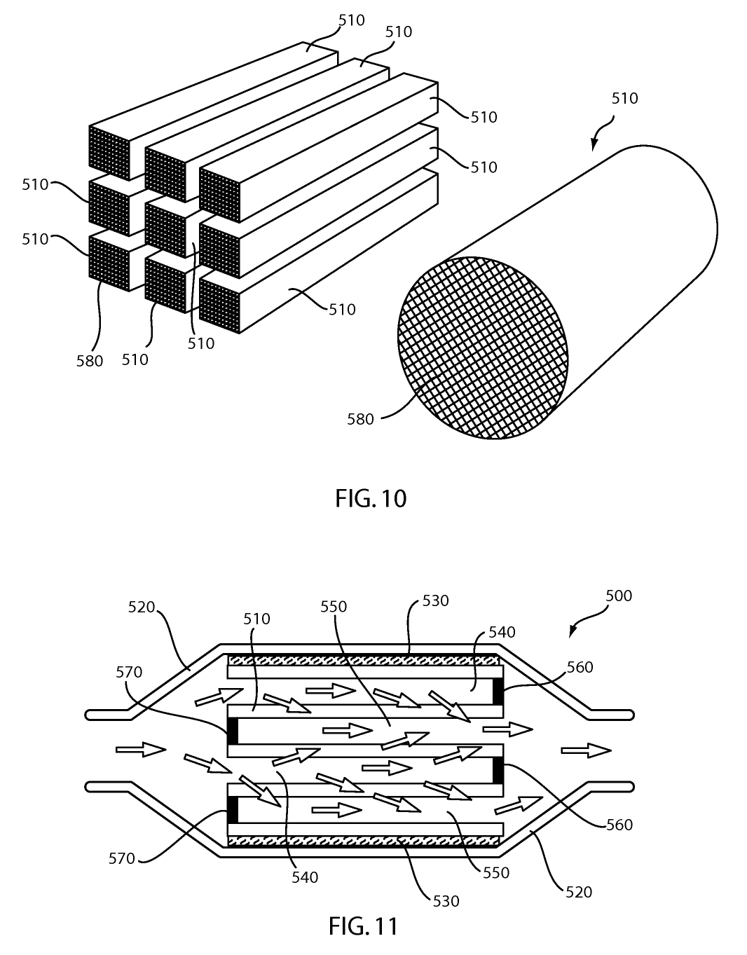

FIG. 10 depicts exemplary honeycomb substrates 510 produced by the methods of the present invention. The substrate 510 has an array of channels 580 that are each separated by channel walls comprising the fibrous silicon carbide structure herein described. The substrate 510 can be fabricated in any number of shapes, such as cylinders or rectangular modules that can be glued together in an array to form a segmented substrate.

FIG. 11 depicts a cross-sectional representation of a high temperature filtration device 500 with a honeycomb filter 510 produced by the methods of the present invention. The filter device 500 typically has the form of a housing 520 supporting the honeycomb filter 510 with an intumescent mat 530 to form an air-tight seal between the housing 520 and the filter 510. The filter 510 is configured in a wall-flow configuration by selectively plugging alternate channels, with inlet channel blocks 560 and outlet channel blocks 570 to form a plurality of respective inlet channels 540 and outlet channels 550. In this configuration, the open network of pores created by the space between the silicon carbide fibers resulting from the methods of fabrication according to the present invention provides sufficient porosity and permeability necessary to permit flow through the porous walls between the inlet channels and the adjacent outlet channels. In this way, particulate matter can be accumulated on the surface of the inlet channel walls, and be thus removed from the filtrate stream through the filter device 500. The resulting fibrous silicon carbide substrate 510 can also be coated with a catalyst to facilitate oxidation of accumulated soot and to accelerate the conversion of exhaust gas into less-harmful constituents.

Any number of catalysts and washcoats can be disposed within the honeycomb filter 510 to chemically alter combustion byproducts in the exhaust stream by catalysis. Such a catalyst includes but is not limited to platinum, palladium (such as palladium oxide), rhodium, derivatives thereof including oxides, and mixtures thereof. In addition, the catalysts are not restricted to noble metals, combination of noble metals, or only to oxidation catalysts. Other suitable catalysts and washcoats include chromium, nickel, rhenium, ruthenium, silver, osmium, iridium, platinum, tungsten, barium, yttrium, neodymium, lanthanum, gadolinium, praseodymium, and gold, derivatives thereof, and mixtures thereof Other suitable catalysts include binary oxides of palladium, aluminum, tungsten, cerium, zirconium, and rare earth metals. Other suitable catalysts include vanadium and derivatives thereof, e.g., V2O5, or silver or copper vanadates, particularly when sulfur is present in the fuel or lubricant. Further still, the substrate 510 can be configured with a combination of catalysts applied to different sections or zones to provide a multi-functional catalyst. For example, the substrate 510 can be used as a particulate filter with soot-oxidizing catalysts applied to the inlet channel walls, with a NOx adsorber, or selective catalyst reduction catalyst applied to the internal fibrous structure in the channel walls. Similar configurations can be applied to provide NOx traps or 4-way catalytic converters.

### EXAMPLES

To further illustrate the principles of the present invention, described herein are certain examples of extruded silicon carbide fibrous structures formed according to the invention. However, it is to be understood that the examples are given for illustrative purpose only, and the invention is not limited thereto, but various modifications and changes may be made in the invention without departing from the spirit of the invention.

In a first example, a material batch mixture was mixed together with the following materials in relative quantities represented as a percentage of the total weight of the mixture:

| | |
|---|---|
| chopped carbon fiber | 17.9% |
| colloidal silica (50% solution in water) | 59.7% |
| hpmc | 10.0% |
| deionized water | 12.4% |

In this example, an approximately stoichiometric molar ratio is attained for the formation of silicon carbide from carbon fibers and colloidal silica. The mixture was then extruded through a 100 cpsi die with a 0.030″ wall thickness to obtain a honeycomb structure having a one inch diameter and approximately one inch length. The green honeycomb substrate was then put in a nitrogen purged oven heated to 200° Celsius for approximately four hours to dry, and then with an increase in temperature to approximately 325° Celsius, heated for approximately two hours to completely burn out the HPMC binder. In a carbon-lined vacuum oven, heated to 1550° Celsius, for approximately two hours, the silicon carbide fibrous structure was formed.

In a second example, a material batch mixture was mixed together with the following materials in relative quantities represented as a percentage of the total weight of the mixture:

| | |
|---|---|
| chopped carbon fiber | 16.7% |
| colloidal silica (50% solution in water) | 32.4% |
| hpmc | 9.3% |
| deionized water | 41.6% |

In this example, an approximately stoichiometric molar ratio is attained for the formation of silicon carbide from carbon fibers and colloidal silica, with excess silica available for the formation of glass/ceramic bonds between adjacent fibers. The mixture was then extruded through a 100 cpsi die with a 0.030″ wall thickness to obtain a honeycomb structure having a one inch diameter and approximately one inch length. The green honeycomb substrate was then put in a nitrogen purged oven heated to 200° Celsius for approximately four hours to dry, and then with an increase in temperature to approximately 325° Celsius, heated for approximately two hours to completely burn out the HPMC binder. In a carbon-lined vacuum oven, heated to 1550° Celsius, for approximately two hours, the silicon carbide fibrous structure was formed.

In a third example, a material batch mixture was mixed together with the following materials in relative quantities represented as a percentage of the total weight of the mixture:

| | |
|---|---|
| chopped carbon fiber | 17.6% |
| silicon metal powder (approximately 45 μm) | 41.2% |
| hpmc | 11.8% |
| deionized water | 29.4% |

In this example, an approximately stoichiometric molar ratio is attained for the formation of silicon carbide from carbon fibers and silicon metal. The mixture was then extruded through a 100 cpsi die with a 0.030″ wall thickness to obtain a honeycomb structure having a one inch diameter and approximately one inch length. The green honeycomb substrate was then put in a nitrogen purged oven heated to 200° Celsius for approximately four hours to dry, and then with an increase in temperature to approximately 325° Celsius, heated for approximately two hours to completely burn out the HPMC binder. In a carbon-lined vacuum oven, heated to 1550° Celsius, for approximately two hours, the silicon carbide fibrous structure was formed.

In a fourth example, a material batch mixture was mixed together with the following materials in relative quantities represented as a percentage of the total weight of the mixture:

| | |
|---|---|
| chopped carbon fiber | 16.3% |
| silicon metal powder (approximately 45 μm) | 45.7% |
| hpmc | 10.9% |
| deionized water | 27.2% |

In this example, an approximately stoichiometric molar ratio is attained for the formation of silicon carbide from carbon fibers and silicon metal, with excess silicon metal available for the formation of metal bonds between adjacent fibers. The mixture was then extruded through a 100 cpsi die with a 0.030″ wall thickness to obtain a honeycomb structure having a one inch diameter and approximately one inch length. The green honeycomb substrate was then put in a nitrogen purged oven heated to 200° Celsius for approximately four hours to dry, and then with an increase in temperature to approximately 325° Celsius, heated for approximately two hours to completely burn out the HPMC binder. In a carbon-lined vacuum oven, heated to 1550° Celsius, for approximately two hours, the silicon carbide fibrous structure was formed.

In a fifth example, a material batch mixture was mixed together with the following materials in relative quantities represented as a percentage of the total weight of the mixture:

| | |
|---|---|
| chopped carbon fiber | 16.2% |
| silicon metal powder (approximately 45 μm) | 37.8% |
| bentonite | 2.7% |
| hpmc | 10.8% |
| deionized water | 32.4% |

In this example, an approximately stoichiometric molar ratio is attained for the formation of silicon carbide from carbon fibers and silicon metal, but with the addition of a clay material, bentonite, to permit the formation of clay/ceramic bonds between adjacent fibers. The mixture was then extruded through a 100 cpsi die with a 0.030″ wall thickness to obtain a honeycomb structure having a one inch diameter and approximately one inch length. The green honeycomb substrate was then put in a nitrogen purged oven heated to 200° Celsius for approximately four hours to dry, and then with an increase in temperature to approximately 325° Celsius, heated for approximately two hours to completely burn out the HPMC binder. In a carbon-lined vacuum oven, heated to 1550° Celsius, for approximately two hours, the silicon carbide fibrous structure was formed.

In a sixth example, a material batch mixture was mixed together with the following materials in relative quantities represented as a percentage of the total weight of the mixture:

| | |
|---|---|
| chopped carbon fiber | 14.7% |
| silicon metal powder (approximately 45 μm) | 34.3% |
| titanium metal powder (approximately 45 μm) | 11.8% |
| hpmc | 9.8% |
| deionized water | 29.4% |

In this example, an approximately stoichiometric molar ratio is attained for the formation of silicon carbide from carbon fibers and silicon metal, but with the addition of titanium metal powder to permit the formation of metal bonds between adjacent fibers. The mixture was then extruded through a 100 cpsi die with a 0.030″ wall thickness to obtain a honeycomb structure having a one inch diameter and approximately one inch length. The green honeycomb substrate was then put in a nitrogen purged oven heated to 200° Celsius for approximately four hours to dry, and then with an increase in temperature to approximately 325° Celsius, heated for approximately two hours to completely burn out the HPMC binder. In a carbon-lined vacuum oven, heated to 1550° Celsius, for approximately two hours, the silicon carbide fibrous structure was formed.

In a seventh example, a material batch mixture was mixed together with the following materials in relative quantities represented as a percentage of the total weight of the mixture:

| | |
|---|---|
| chopped carbon fiber | 15.9% |
| silicon metal powder (approximately 45 μm) | 37.1% |
| aluminum metal powder (approximately 45 μm) | 7.2% |
| hpmc | 10.6% |
| deionized water | 29.2% |

In this example, an approximately stoichiometric molar ratio is attained for the formation of silicon carbide from carbon fibers and silicon metal, but with the addition of aluminum metal powder to permit the formation of metal bonds between adjacent fibers. The mixture was then extruded through a 100 cpsi die with a 0.030″ wall thickness to obtain a honeycomb structure having a one inch diameter and approximately one inch length. The green honeycomb substrate was then put in a nitrogen purged oven heated to 200° Celsius for approximately four hours to dry, and then with an increase in temperature to approximately 325° Celsius, heated for approximately two hours to completely burn out the HPMC binder. In a carbon-lined vacuum oven, heated to 1550° Celsius, for approximately two hours, the silicon carbide fibrous structure was formed.

In an eighth example, a material batch mixture was mixed together with the following materials in relative quantities represented as a percentage of the total weight of the mixture:

| | |
|---|---|
| chopped carbon fiber | 18.8% |
| silicon metal powder (approximately 45 μm) | 43.8% |
| SMP-10 SiC precursor-polymer solution | 6.3% |
| ethyl cellulose | 12.5% |
| toluene | 18.8% |

In this example, an approximately stoichiometric molar ratio is attained for the formation of silicon carbide from carbon fibers and silicon metal, but with the addition of a preceramic polymer to form polymer bonds between the fibers, resulting in silicon carbide bonded silicon carbide fibers after firing. The mixture was then extruded through a 100 cpsi die with a 0.030″ wall thickness to obtain a honeycomb structure having a one inch diameter and approximately one inch length. The green honeycomb substrate was then put in a nitrogen purged oven heated to 200° Celsius for approximately four hours to dry, and then with an increase in temperature to approximately 325° Celsius, heated for approximately two hours to completely burn out the HPMC binder. In a carbon-lined vacuum oven, heated to 1550° Celsius, for approximately two hours, the silicon carbide fibrous structure was formed.

In a ninth example, a material batch mixture was mixed together with the following materials in relative quantities represented as a percentage of the total weight of the mixture:

| | |
|---|---|
| West Systems 403 Microfibers | 16.7% |
| silicon metal powder (approximately 45 μm) | 38.9% |
| hpmc | 11.1% |
| deionized water | 33.3% |

In this example, an approximately stoichiometric molar ratio is attained for the formation of silicon carbide from carbonized organic fibers and silicon metal. West Systems 403 Microfibers are wood/paper based fiber filler typically used in resin-epoxy mixtures, which carbonize into carbon fiber during the firing operations. The mixture was then extruded through a 100 cpsi die with a 0.030″ wall thickness to obtain a honeycomb structure having a one inch diameter and approximately one inch length. The green honeycomb substrate was then put in a nitrogen purged oven heated to 200° Celsius for approximately four hours to dry, and then with an increase in temperature to approximately 325° Celsius, heated for approximately two hours to completely burn out the HPMC binder. In a carbon-lined vacuum oven, heated to 1550° Celsius, for approximately two hours, the organic fibers carbonized and the silicon carbide fibrous structure was formed.

The present invention has been herein described in detail with respect to certain illustrative and specific embodiments thereof, and it should not be considered limited to such, as numerous modifications are possible without departing from the spirit and scope of the appended claims.

What is claimed is:

1. A method for producing a fibrous silicon carbide substrate, the method comprising:
mixing organic fibers with additives comprising silicon and a binder, and a fluid to provide an extrudable mixture;
extruding the extrudable mixture into a green substrate; and
heating the green substrate to carbonize the organic fibers into carbon fibers to form silicon carbide fibers using the carbon fiber and the additives.

2. The method according to claim 1 wherein the heating step further comprises:
heating the green substrate to a first temperature to remove substantially all of the fluid;
heating the green substrate to a second temperature to remove the binder portion of the additives;
heating the green substrate to a third temperature to carbonize the organic fiber; and
heating the green substrate to a fourth temperature to form silicon carbide.

3. The method according to claim 2 wherein the fourth temperature is at least 1400° Celsius.

4. The method according to claim 1 wherein the additives further comprise silicon metal particles.

5. The method according to claim 1 wherein the additives further comprise silica particles.

6. The method according to claim 1 wherein the additives further comprise methylcellulose.

7. The method according to claim 1 wherein the organic fibers further comprise at least one of a rayon fiber, cotton fiber, wood fiber, paper fiber, and polymeric resin filament.

8. The method according to claim 1 wherein the additive further comprises at least one of a pore former, a plasticizer, and a dispersant.

9. A method for producing a fibrous silicon carbide substrate comprising:
mixing organic fibers with colloidal silica, an organic binder, and a fluid to provide an extrudable mixture;
extruding the extrudable mixture into a green substrate;
removing the fluid from the green substrate;
decomposing the organic binder;
carbonizing the organic fibers into carbon fibers; and
reaction forming silicon carbide using the carbon fibers and the colloidal silica.

10. The method according to claim 9 wherein the mixing step further comprises a bonding agent, and the forming step further comprises forming bonds using the bonding agent.

11. The method according to claim 10 wherein the organic fibers comprise at least one of a rayon fiber, cotton fiber, wood fiber, paper fiber, and polymeric resin filament.

12. The method according to claim 111 wherein the organic fibers have an aspect ratio between 1 and 1000.

13. A porous ceramic substrate comprising:
a structure comprising silicon carbide fibers formed from a reaction of a mixture of carbonized organic fibers and silicon-based additives, the silicon carbide fibers forming a network of open pores;
a plurality of channels formed at least partially through the structure;
at least one of the plurality of channels configured as an inlet channel; and
at least one other of the plurality of channels configured as an outlet channel.

14. The substrate according to claim 14 wherein the structure further comprises at least one of a metal bond, a ceramic bond, a glass bond, and a polymer bond, between adjacent silicon carbide fibers.

15. The substrate according to claim 13 wherein the plurality of channels are formed by extrusion.

16. The substrate according to claim 13 wherein the carbonized organic fibers further comprise at least one of a rayon fiber, cotton fiber, wood fiber, paper fiber, and polymeric resin filament.

17. A filter comprising:
a housing having an inlet and an outlet;
an extruded honeycomb substrate mounted within the housing, the substrate comprising;
a honeycomb array of channels forming porous walls between adjacent channels;
the walls having a structure comprising an open network of pores formed from intertangled silicon carbide fibers formed from a reaction of carbonized organic fibers and silicon-based additives;
the array of channels configured as a set of inlet channels and a set of outlet channels; and
wherein a flow through the filter housing passes from the inlet into the inlet channels, through the porous walls, into the outlet channels and directed out the outlet.

18. The filter according to claim 17 wherein the intertangled silicon carbide fibers are at least partially bonded with a metal bond.

19. The filter according to claim 17 wherein the intertangled silicon carbide fibers are at least partially bonded with a glass or ceramic bond.

20. The filter according to claim 17 wherein the intertangled silicon carbide fibers are at least partially bonded with a polymer bond.
